(19) United States
(12) Patent Application Publication
(10) Pub. No.: US 2020/0021463 A1
(43) Pub. Date: Jan. 16, 2020

(54) COMPUTER SYSTEM HAVING CONTROLLER CONFIGURED TO CREATE DATA TUNNEL BASED ON DEVICE INFORMATION

(71) Applicant: Dwight L. Stewart, Johnston, IA (US)

(72) Inventor: Dwight L. Stewart, Johnston, IA (US)

(21) Appl. No.: 16/513,269

(22) Filed: Jul. 16, 2019

Related U.S. Application Data
(60) Provisional application No. 62/698,615, filed on Jul. 16, 2018.

(51) Int. Cl. H04L 12/46

(52) U.S. Cl. CPC H04L 12/4633

(57) ABSTRACT

Example embodiments relate to a system in which data is tunneled from a node to a server after the device is identified by a controller.

### CROSS REFERENCE TO RELATED APPLICATIONS

This application claims the benefit of U.S. Patent Application No. 62/698,615 which was filed with the United States Patent and Trademark Office on Jul. 16, 2018, the entire contents of which is herein incorporated by reference.

### BACKGROUND

### 1. Field

Example embodiments relate to a system in which data is tunneled from a node to a server after the device is identified by a controller.

### 2. Description of the Related Art

USB devices often connect to a computer either directly or through a cable. The computer then obtains data from the USB device which helps the computer understand the nature of the device. For example, cameras, printers, and speakers are often preloaded with metadata which can be uploaded to a computer for identification. The computer, once the nature of the device is understood, may have software loaded therein which can be used to control the USB device or manage data from the USB device.

### SUMMARY

Example embodiments relate to a system in which data is tunneled from a node to a server after the device is identified by a controller. The system uses electronic nodes to which various devices, for example, USB devices, connect. In one example of the system, the nodes deliver data from the devices to a controller which identifies the device and then sends information back to the node which provides the node with the identity of a server to which device information may be sent. In another example of the system, the controller sends a server USB tunneling service information so the server may establish the tunnel with the node.

### BRIEF DESCRIPTION OF THE DRAWINGS

Example embodiments are described in detail below with reference to the attached drawing figures, wherein:

FIG. 1 is a view of a system in accordance with example embodiments;

FIG. 2 is a view of another system in accordance with example embodiments;

FIG. 3 is a view of another system in accordance with example embodiments;

FIG. 4 is a view of a node in accordance with example embodiments;

FIG. 5 is a view of a server in accordance with example embodiments;

FIG. 6 is a view of a system in accordance with example embodiments; and

FIG. 7 is a view of a data table in accordance with example embodiments.

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example Embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a system in which data is tunneled from a node to a server after the device is identified by a controller.

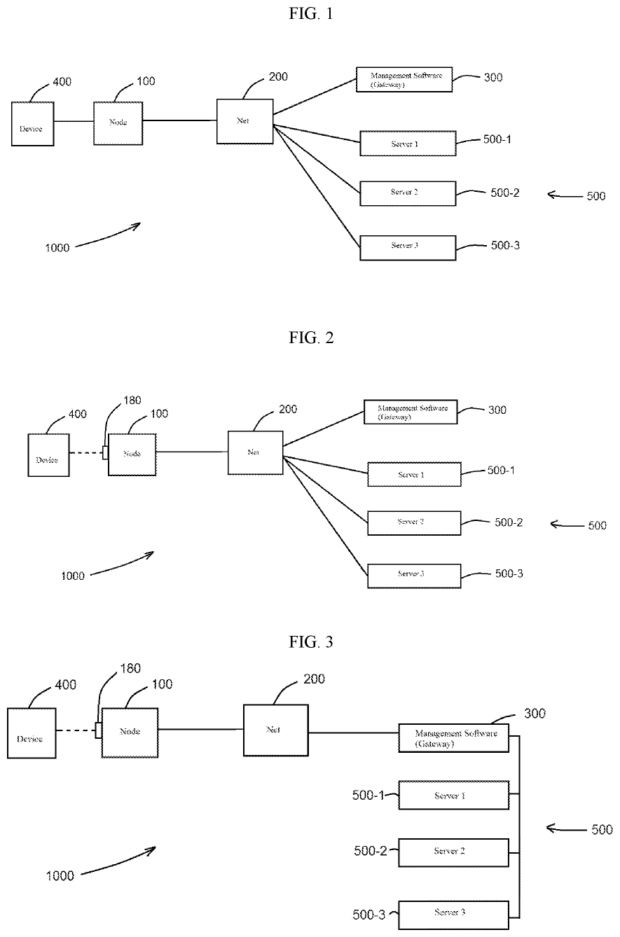

FIG. 1 is a view of a computer system 1000 in accordance with example embodiments. In FIG. 1, the computer system 1000 may be comprised of a node 100 attached to a network 200 which in turn connects to a controller 300, for example, a computer having management software. In this nonlimiting example embodiment, the controller 300 may be configured to control the system 1000. In example embodiments, a device 400, for example, a USB device, may connect to the node 100 and provide data to the node 100.

In example embodiments, the connection from the device 400 to the node 100 may be wireless or over wire. For example, in one nonlimiting example embodiment, the node 100 may include a port to which a conventional Ethernet cable may attach. Thus, the device 400 may connect to the node 100 via an Ethernet cable. In the alternative, the node 100 may be fit with a dongle 180 which may allow the node 100 to receive data wirelessly. For example, FIG. 2 shows system 1000 wherein the node 100 includes a dongle 180 connected to the node 100 to receive data wirelessly from the device 400. In the nonlimiting example of FIG. 2, the dongle 180 may be configured to receive an electronic signal, for example, Bluetooth signal. It is understood that while an Ethernet cable may be used to connect the device 400 to the node 100 other types of data and/or data connections may be used. Similarly, while Bluetooth is used as an example of a type of signal which may be received by the dongle 180, the dongle 180 may be configured to receive another type of signal.

The instant invention is not limited to the above configurations. For example, FIG. 3 is a view of system 1000 where data flows from the node 100, through network 200, and to controller 300 where the data flows to the servers 500. In this nonlimiting example embodiment, because the data flows through controller 300, a system administrator can restrict communications between network devices, such that peer-to-peer communication or multiple-server communication is difficult.

In example embodiments, the system 1000 may include a plurality of servers 500. For example, in the nonlimiting example of FIGS. 1, 2 and 3, the plurality of servers 500 may be comprised of a first server 500-1, a second server 500-2, and a third server 500-3. Though FIGS. 1, 2 and 3 illustrate the plurality of servers 500 as being comprised of three servers 500-1, 500-2, and 500-3, the plurality of servers may be comprised of only two servers or more than three servers. In other words, the number of servers illustrated in FIGS. 1, 2 and 3 is meant for purposes of illustration only and is not intended to limit the invention.

In example embodiments, the plurality of servers 500 may serve a plurality of functions. For example, the first server 500-1 may be configured to control one or more printers. The second and third servers 500-2 and 500-3 may be configured to manage other types of devices, for example, USB devices such as, but not limited to, cameras and/or speakers.

In example embodiments, the plurality of servers 500 may include various software modules. For example, as shown in FIG. 5, a server 500 may include an operating system 510 (for example, Windows), along with a tunnel service 520, and a server application 530, for example, a Bluecats server application.

In example embodiments, each of the elements may include a unique identifier. For example, each of the devices 100, 200, 300, 400, and 500 may have their own IP addresses or MAC addresses (which may be examples of unique identifiers). In another example, the unique identifiers may be autogenerated. For example, the nodes 100 may generate their own unique identifiers.

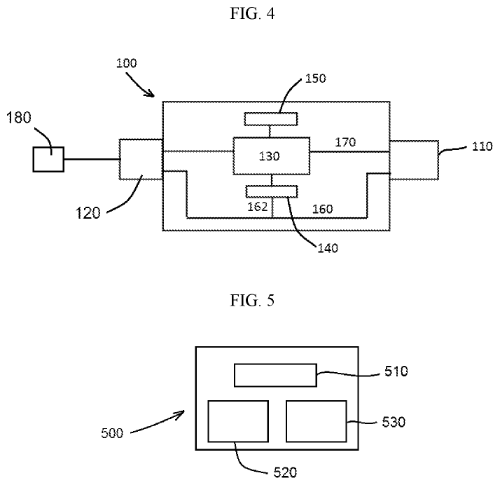

FIG. 4 is a view of a node 100 in accordance with example embodiments. As shown in FIG. 4, the node 100 may include an input port 110 and an output port 120. In example embodiments, each of the input port 110 and the output port 120 may be configured to receive a conventional Ethernet cable. Thus, the node 100 may be capable of receiving both data and power. In one nonlimiting example embodiment, the power and data may be provided to the node 100 via PoE, however, this is merely for purposes of illustration only since data and power may flow to the node 100 by a scheme other than PoE such as but not limited to Wi-Fi, LTE, 4G, 5G, Bluetooth, etc.

In Example embodiments, the node 100 may include a microprocessor 130 and a memory 150. The microprocessor 130 may be configured to receive data from the input port 110 transmit data to the output port 120, receive data from the output port 120, and transmit data to the input port 110. Thus, in example embodiments, data may flow in two directions through the node 100. The memory 150 may be configured to store various types of information, for example, the node's IP address or MAC address or information regarding a device that may be connected to the node or information which may be used by the node 100 to communicate data.

In FIG. 4, the node 100 may include a first power source 140 configured to provide power to the microprocessor 130. In example embodiments, the first power source 140 may be configured to receive power via conductive lines 160 and 162 which may receive power from the input port 110. For example, when an Ethernet cable is inserted into the input port 110, power may flow to the first power source 140 via the conductive lines 160 and 162. In example embodiments, the conductive member 160 may terminate at the output port 120. Thus, in example embodiments, power may also flow from the input port 110 to the output port 120 via the conductive member 160. In example embodiments, power may be modified, controlled, and protected before it is provided to dongle 180. For example, PoE may provide 50 V, and the node 100 may use a switching power supply to provide a connected peripheral (e.g. USB) device with 5V power. Also, the microprocessor 130 may choose to turn off power to a connected peripheral, for conserving power or resetting the attached peripheral. Circuitry such as a fuse and other protective circuitry may be used to protect the node 100.

In FIG. 4, the microprocessor 130 may receive data from the input port 110. For example, in example embodiments, the microprocessor 130 may receive data via a conductive member 170. In example embodiments, the microprocessor 130 may use the data to control the powered device 160. In addition, or in the alternative, the microprocessor 130 may transfer the data to the output port 120 via another conductive member 172. In example embodiments, the microprocessor 130 may also be configured to receive data from the output port 120 and transfer this data to the input port 110. Thus, in example embodiments, data may flow two ways across the node 100.

In example embodiments, when device 400 connects to node 100, for example, via an Ethernet cable or via wireless connection, the device 400 may upload data, for example, metadata, to node 100. Node 100 may, in turn, package this data and send the data, along with the node's identifier, to the controller 300. In this way, the controller 300 can identify the nature of the device 400 and know the identity of the node connected to the device 400. For example, if the device 400 is a printer, the device 400 may upload data identifying itself as a printer and the node 100 may send this information along with its unique identifier to the controller 300. The controller 300 may identify the device 400 as a printer and may send information back to the node 100 along with information identifying a server 500 to which at least some future information should be sent. This may allow the node 100 to properly direct information from the device 400 to one of the servers of system 1000. For example, data from the controller 300 may inform the node 100 that the server to which it should tunnel information is server 500-1. Thus, when data is generated and sent by device 400 the node 100 may couple this data along with the server identification number for server 500-1 so that server 500-1 will receive and utilize the data from the device 400. As yet another example, if the device 400 is a camera the camera may send data to node 100 when it is connected to node 100. In response, node 100 may couple this data to its own unique identifier and then send this data to controller 300. Controller 300 may understand, via the data transmitted by the node 100, that the device 400 is a camera and may respond by sending to node 100 an identifier identifying which server node 100 should tunnel its data to. In example embodiments, any one of the servers 500 may also be provisioned by the controller 300, such that it only accepts tunnels from specific nodes 100. This may prevent unauthorized tunneling to penetrate a server 500.

It is understood that the some data may be sent to the controller 300 after tunnels are created. For example, control, debug, statistics, and telemetry communications from the node 100 may still be sent to server 300 to allow the controller 300 to continuously manage the system 1000 and react. For example, the controller 300 may analyze the telemetry data of a device 400 and determine the device 400 is untrusted and command the node 100 or server 500 to disconnect from the tunnel. In addition, the controller 300 may analyze various data for the purpose of load balancing. For example, each server 500 may only be able to handle a limited number of tunnels, therefore, situations may exist where multiple similar servers 500 will need to exist to handle all the tunnels. Controller 300 may use a tunnel data (statistics and telemetry) to determine how to best balance the pairing of the devices 400 with the servers 500 by accounting for numerous factors including each server's unique utilization of CPU memory, disk space, etc. Various dynamic and static tunneling policies may be used to pair devices 400 with servers 500. A static policy, for example, may state a specific device 400 will absolutely be paired with a server 500 whereas a dynamic policy may pair a device 400 with a server 500 based on the type of device, CPU load, and memory utilization, disk availability user-specified tunnel limit, application specified tunnel limit (e.g. certain server applications may only work with a certain number of USB devices), or operating system tunnel limit (e.g. Windows can only have a certain number of comm ports or Y number of USB devices).

The invention, of course, is not limited by the above disclosure. For example, in another nonlimiting example embodiment, the controller 300 may, at any time, send a discovery signal to node 100 to query whether or not node 100 is attached to a device 400. If so, node 100 may pull data from device 400, couple this data to its own unique identifier, and send this data to the controller 300. The controller 300 may then understand the type of device attached to node 100 and may send back to node 100 the identity of the server to which it should send data received by the device 400.

In example embodiments there may be times when the data initially sent by node 100 to controller 300 is insufficient to allow controller 300 to identify the device 400. In this case, controller 300 may send a message back to node 100 to request additional information from the device 400 be sent to controller 300. If the additional information provides enough information regarding the identity of the device 400 the controller 300 may inform the node 100 the identification of the proper server 500 to which node 100 should send future data. On the other hand, if the data is still not sufficient, the controller 300 may simply not provide node 100 with the identity of a server 500 to which information should be sent.

In example embodiments, the controller 300 may try and obtain information from the device 400 by querying the device using various protocols. For example, the controller 300 may be configured to send a request for data using a first protocol. If the device 400 does not respond within a preset or predetermined time limit, the controller 300 may request information using a second protocol. If the device 400 does not respond within a preset or predetermined time limit, the controller 300 may request information using a third protocol and so on until the device 400 responds with the appropriate identifying information. Consistent with the above examples, if the device 400 is identified, the controller 300 may provide node 100 with the identifier of the appropriate server 500 to which data may be sent. Of course, if the device 400 is unable to be identified, the server 300 may send a signal to node 100 indicating node 100 will not tunnel data from device 400.

In example embodiments, node 100 may be configured, for example, statically configured, to use a specific protocol and may also require a specific configuration. For example, the node 100 may be configured with a DMX protocol and configured to know there is a color light on a DMX channel. In this case, node 100 may further extend the data tunnel by supporting new data requests beyond what device 400 natively provides. Node 100 may, for example, override data requests device 400 supports and process those commands within node 100 rather than have device 400 process them, block commands even for commands device 400 supports, only transmit commands that node 100 allows, and/or add support for data requests that device 400 does not support and process those commands with node 100 rather than have device 400 process them. By way of example only, if DMX doesn't support a command for returning a list of lights, then device 100 may support overriding, adding, or blocking commands for getting a list of lights. To do this, node 100 may monitor the data tunnel and intercept a command using node 100's protocol configuration such that its tunnel-attached server 500 may issue a request to get a list of lights and node 100 intercepts that command and replies to server 500 without involving device 400. In the event the data tunnel is routing through the controller 300, then the controller 300 may monitor and intercept tunnel data and may itself perform these operations of overriding, adding, blocking, or allowing data requests. Also, the tunnel service or the server 500 may monitor and intercept tunnel data and may itself perform these operations of overriding, adding, blocking, or allowing data requests. Controller 300 may provision node 100, controller 300, or server 500 for these actions of overriding, adding, blocking or allowing data requests. This may result in a more centralized, manageable experience for numerous devices 400, nodes 100, and servers 500.

The instant method of controlling a computer system has various advantages over the prior art. In the prior art nodes are generally configured to identify the device to which they are attached. However, these nodes are relatively expensive in that they require a chip configured to identify various devices, for example, USB devices. In the present case, the device identification is performed at a controller remote from the node. As such, the nodes may be manufactured at a lesser cost since the nodes themselves are not required to identify the device which attaches to them.

In example embodiments, the controller 300 may undertake additional operations. For example, if the device 400 cannot be identified, the controller 300 may control the system 1000 so that the device 400 cannot access the network in the event it fails to provide a proper MAC address or certificate.

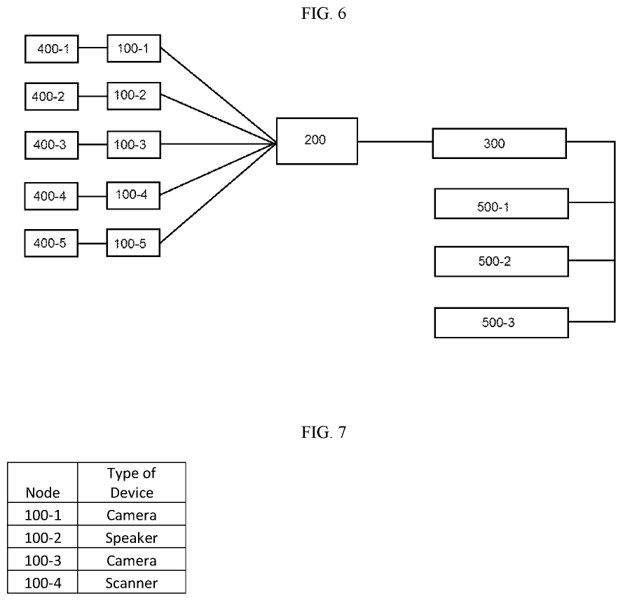

FIG. 6 is another example of a system 1000 in accordance with example embodiments. The system 1000 of FIG. 6 is somewhat similar to the systems 1000 described in FIGS. 1-3. In FIG. 6, the system 1000 includes a plurality of nodes 100-1, 100-2, 100-3, 100-4, and 100-5 to which a plurality of devices 400-1, 400-2, 400-3, 400-4, and 400-5 is connected. Although only four nodes and four devices are illustrated in FIG. 6 it is understood there may be more or less than four nodes and more or less than four devices. As such, the number of nodes and devices illustrated in FIG. 6 is for the purpose of illustration only.

In the system 1000 of FIG. 6 the plurality of nodes 100-1, 100-2, 100-3, 100-4, and 100-5 may be substantially identical to node 100. In FIG. 6 the plurality of nodes 100-1, 100-2, 100-3, 100-4, and 100-5 may send data to controller 300 via network 200. For example, as the devices 400-1, 400-2, 400-3, 400-4 and 400-5 connect to the plurality of nodes 100-1, 100-2, 100-3, 100-4, and 100-5 the plurality of devices 400-1, 400-2, 400-3, 400-4, and 400-5 may send device information to the plurality of nodes 100-1, 100-2, 100-3, 100-4, and 100-5 which in turn forwards this information to the controller 300 via network 200. The controller 300, based on the information from the plurality of devices 400-1, 400-2, 400-3, 400-4, and 400-5, may determine the identity of the devices 400-1, 400-2, 400-3, 400-4, and 400-5 and record the devices in an electronic database, for example, a ROM chip, which may be present in the controller 300. This data may, in at least one nonlimiting example embodiment, be accessible by the servers 500. An illustrative example of the electronic database is illustrated in FIG. 7.

In example embodiments, the controller 300 and/or the plurality of servers 500 may include tunneling software which may apply rules to set up tunnels. In this nonlimiting example embodiment, the tunneling software may be used to determine which tunnel(s) a server 500 may accept. For example, in one nonlimiting example embodiment, the controller 300 may include rules which allow the controller 300 to establish tunnels between the nodes 100 and the servers 500. In another embodiment, the servers 500 include tunneling software which determines which nodes the servers 500 will accept or initiate tunnels with. Because the controller 300 and/or servers 500 may establish tunnels or define tunnels, the nodes 100 do not necessarily have to provide server identifiers in data they send. For example, in example embodiments, the device 400-1 may send device data to node 100-1 and node 100-1 may send this data to the controller 300 which may identify the device 400-1. In this case, controller 300 may determine which server 500 future device information may be tunneled to. For example, if device 400-1 is a printer and device 400-1 sends identifying data (for example, meta data) to node 100-1 which in turn forwards the data to controller 300 via the network 200, the controller 300 may identify the device 400-1 as a printer and thereafter establish a tunnel between node 100-1 and a server, for example, 500-1 which may be configured to utilize printer information. In this case, controller 300 is not required to send server identifier information to node 100-1 since future data received at controller 300 from node 100-1 may be tunneled to server 500-1 by controller 300.

In example embodiments, a system manager may utilize tunneling software which may be loaded onto the controller 300 and/or servers 500. This allows a system operator to explicitly associate a node 100 (or device 400) with a server 500. For example, if server 500-1 is configured to manage cameras and nodes 100-1 and 100-3 are connected to cameras, then a system manager may utilize tunneling software on either the controller 300 or the servers 500 to create a data tunnel between node 100-1 and server 500-1 and between node 100-3 and server 500-1. It is understood there are variations of the invention, as such, the invention is not limited by the previous example. For example, the tunneling software may be configured to match devices to servers. For example, if a device identifies itself as a Bluetooth device, the software may automatically associate the device with an appropriate server.

In example embodiments the controller 300 may be configured to send out a discovery request throughout system 1000 in order to trigger the devices 400 to send identifying information. The controller 300 may receive this information and store this information in a table which is accessible by the servers 500. As such, a system manager may access the device information and explicitly assign nodes to servers. In addition, the servers 500 may be configured to crawl through the information in the table to determine whether it can accommodate a device in the table. If so, the server may establish a tunnel between that device and the server.

In example embodiments it is envisioned that certain servers may go offline. To remedy such an event, the controller may monitor the plurality of servers 500 to detect when a server 500 goes off line. For example, in one embodiment the servers 500 are each configured to send a periodic signal to the controller 300. In the event the controller 300 does not receive the signal within a preset time period, the controller 300 may assume the server has gone offline. In response, the server 300 may be configured to create a different tunnel for a node so that data from the node is sent to a proper server. For example, if device 400-1 is a printer and servers 500-1 and 500-2 are configured to receive and utilize print commands, the controller 300 may set up a tunnel between device 400-1 and server 500-1. However, if controller 300 does not receive an expected signal within a preset time period from server 500-1, the controller may establish a new tunnel between node 100-1 and server 500-2. As another example, the controller 300 may periodically send a signal to any one of, or all of, the servers 500-1 requesting a return signal to determine whether the server is offline. If the server does not respond within a preset time period, the controller 300 may determine the server if offline and utilize this information to create, destroy, or recreate a tunneled connection between a node and a server.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A system comprising:
a node having a unique identifier;
a controller; and
a least one server, wherein the node is configured to receive device data, couple the unique identifier to the device data and send the coupled unique identifier and device data to the controller and the controller is configured to receive the device information from the node.

2. The system of claim 1, wherein the node is further configured to couple device data with the unique server identification number and send the coupled device data and unique server identification number to a network.

3. The system of claim 2, wherein the controller receives the coupled device data and unique server identification number from the network.

4. The system of claim 2, wherein the network transfers the coupled device data and the unique server identification number to the server associated with the unique server identification number.

5. The system of claim 1, wherein the device is connected to the node wirelessly.

6. The system of claim 5, wherein the node receives a Bluetooth signal from the device.

7. The system of claim 1, wherein the device is a USB device.

8. The system of claim 7, wherein the USB device sends device identifying information to the node.

9. The system of claim 1, wherein the device is connected to the node via an Ethernet cable.

10. The system of claim 9, wherein the device is a USB device.

11. The system of claim 1, wherein at least one of the node, the controller, a tunnel service, and the at least one server is configured to at least one of override data requests, block data requests, and process data requests using one of a preset protocol and data route.

12. The system of claim 1, wherein the controller is configured to query the device using one of a first protocol and data route.

13. The system of claim 12, wherein the controller is configured to query the device using one of a second protocol and data route if the device fails to respond to the first query within a predetermined time period.

14. The system of claim 1, further comprising:
a network between the node and the controller.

15. The system of claim 1, wherein data from the node flows through the network and to the controller.

16. The system of claim 1, wherein the controller is configured to determine the device based on the device data.

17. The system of claim 1, wherein the controller is configured to send a unique server identification number to the node.

18. The system of claim 1, wherein the controller is configured to determine the device based on the device data and send a unique server identification number to the node.
